(19) United States
(12) Patent Application Publication
(10) Pub. No.: US 2010/0199846 A1
(43) Pub. Date: Aug. 12, 2010

(54) APPLIANCE FOR DISPENSING BEVERAGES

(75) Inventors: Sandra Aus Der Fuenten, Bielefeld (DE); Gerald Aengenheyster, Minden (DE); Nils Krutemeyer, Kirchlengern (DE)

Correspondence Address: VENABLE LLP, P.O. BOX 34385, WASHINGTON, DC, 20043-9998, US

(73) Assignee: Melitta Haushaltsprodukte GmbH & Co. KG, Minden (DE)

(21) Appl. No.: 12/700,544

(22) Filed: Feb. 4, 2010

(30) Foreign Application Priority Data
Feb. 6, 2009 (DE) 20 2009 001 490.8

(51) Int. Cl. B67D 7/78; A47J 31/44; F25C 5/02; G05D 7/00

(52) U.S. Cl. 99/279; 99/300; 62/320; 700/283

(57) ABSTRACT

An appliance for dispensing a beverage includes a brewing unit through which hot water can flow through an extraction substance to produce a brewed beverage. A collecting container is arranged to receive the brewed beverage from the brewing unit. A beverage dispenser is arranged to receive a prepared beverage from the collecting unit and to fill a container with the prepared beverage. A device is arranged to supply ice to the collecting container. The brewed beverage is permitted to flow through the collecting container with the ice therein as the prepared beverage to the beverage dispenser.

### CROSS-REFERENCE TO RELATED APPLICATION

This application claims the priority of German Patent Application No. DE 20 2009 001 490.8, filed on Feb. 6, 2009, the subject matter of which is incorporated herein by reference.

### BACKGROUND OF THE INVENTION

The present invention relates to an appliance for dispensing beverages, in particular coffee, comprising a brewing unit through which hot water can flow for extraction and further comprising a beverage dispenser where a container can be filled with a prepared beverage.

A beverage dispenser is known from German patent document DE 22 43 882, in which the dispenser contains a storage container for ice from which a predetermined amount of ice per time interval can be released via an ice dispenser. The ice can then be mixed with the beverage inside a container. A disadvantage of this type of beverage dispenser is that solid particles remain in the beverage which is considered unpleasant by the consumer. The ice chips furthermore dissolve only slowly, meaning it takes a long time for the beverage to cool down, or an excessive amount of ice is used which reduces the taste of the beverage.

German patent document DE 34 05 396 discloses an extract preparation device with a cooling container arranged between a filtering device and a carafe for cooling a beverage. To be sure, the cooling in an additional cooling container which must be filled manually permits the filtering out of solid particles, but a dosing of the correct amount of ice is difficult because the cooling will be more or less effective, depending on the temperature of the brewed coffee, the ambient temperature, and the size of the ice cubes.

### SUMMARY OF THE INVENTION

It is an object of the present invention to provide an appliance for dispensing beverages which allows an effective cooling of a brewed beverage and ensures a constant beverage quality.

The above and other objects are accomplished by the invention wherein in, according to one embodiment, there is provided an appliance for dispensing a beverage, comprising: a brewing unit through which hot water can flow through for extraction to produce a brewed beverage; a collecting container arranged to receive the brewed beverage from the brewing unit; a beverage dispenser arranged to receive a prepared beverage from the collecting unit and to fill a container with the prepared beverage; and a device arranged to supply ice to the collecting container, wherein the brewed beverage is permitted to flow through the collecting container with the ice therein as the prepared beverage to the beverage dispenser.

According to this embodiment, the appliance is provided with a device for supplying the ice to the collecting container, wherein the brewed beverage can flow through the collecting container with ice to the outlet for dispensing the beverage. The device for supplying the ice therefore can meter out the desired amount of the ice, so that depending on the selected beverage volume the required amount of ice can be supplied to the collecting container. The temperature of the dispensed beverage can furthermore be predetermined by the amount of ice that is added, which makes it possible to achieve a reproducible quality for the dispensed beverage, wherein this is especially advantageous when using automatic coffee makers or other types of beverage dispensers.

According to a further embodiment, the collecting container has an outlet provided with a locking valve. As a result, the dwell time during which the brewed beverage with the ice remains inside the collecting container can be specified. The brewed beverage may be released into the collecting container and remain in the container for a period of between 5 and 30 seconds, for example between 10 and 20 seconds, before the cooled-down beverage is released to the beverage dispenser. This action avoids that solid particles remain in the cooled beverage. The dwell time in this case can be set automatically with the aid of a control, in particular when selecting a specific program for the beverage preparation.

According to another embodiment of the appliance, the brewed beverage can optionally be allowed to flow from the brewing unit either directly or via the collecting container to the beverage dispenser. The consumer can thus decide whether to obtain a hot brewed beverage or a cooled beverage.

According to a different embodiment of the invention, the device for supplying the ice is provided with a device for comminuting or crushing the ice. Large pieces of ice require a longer period of time to cool down and will dissolve only slowly. To increase the surface area of the ice, a device may be provided for crushing or comminuting the ice cubes into small ice chips, so that the ice can also be metered out easier to the collecting container. The device for supplying ice can be provided for this with a container in which a driven disc is arranged for comminuting or crushing the ice, wherein this disc cooperates with a corresponding blade. The blade may be adjustable to adjust the size of the comminuted ice pieces.

According to yet another embodiment, the appliance may be provided with an automatic dosage device for supplying ice, wherein this dosage device prevents excessive amounts of ice from being released into the device for supplying the ice. As a result, only the amount of ice needed is released by the dosage device to the device for supplying the ice. The dosage device can comprise a storage container, for example, or a device for accommodating ice cubes which permits the automatic release of one or a plurality of ice cubes to the device for supplying the ice.

According to a different embodiment, the device for supplying the ice can optionally release the ice either to the collecting container or directly into the beverage dispenser. The consumer can therefore decide whether the beverage should contain ice or should only be cooled.

According to yet another embodiment, the appliance may include a control unit, which allows selecting different programs for the automatic dispensing of hot or cold beverages. With the aid of such a control unit, the user can furthermore also select whether to obtain only crushed ice at the beverage output. Furthermore, the appliance may be provided with a mechanism for dosing aromatic substances, in particular syrup, so that the appliance can dispense a plurality of different beverages at different temperatures and with different taste directions.

The collecting container may be funnel-shaped for an effective cooling, such that the force of gravity can be used to operate a switchable valve arranged on the outlet, thereby avoiding unnecessary pumps which can lead to cleaning problems, in particular for the beverage dispensing. The device for supplying the ice is furthermore arranged above the collecting container and the collecting container is arranged above the beverage outlet, so that gravity is used for dispensing the beverages within the production process.

The collecting container may be installed so as to be removable from the appliance, for example inside a pull-out drawer, for an easy cleaning of the container.

### BRIEF DESCRIPTION OF THE DRAWINGS

These and other features and advantages of the invention will be further understood from the following detailed description with reference to the accompanying drawings.

FIG. 1 is a schematic view of an appliance according to an embodiment of the invention for dispensing beverages.

FIG. 2 is a detailed schematic view of the appliance, showing the region of the device for supplying the ice.

FIG. 3 is an enlarged and exploded representation of the device for supplying the ice.

### DETAILED DESCRIPTION

Referring to the Figures, there is shown an appliance 1 for dispensing beverages, in particular coffee. The appliance 1 comprises a device 2 for supplying ice which is installed together with a brewing unit 3 for producing hot beverages inside the appliance 1. The brewing unit 3 is supplied with hot water via a schematically shown feedline 4 while a dosage device 5 provides an extraction substance, such as ground coffee. A desired amount of the ground coffee can be supplied by a grinding device to the brewing unit 3. An output line 6 leads from the brewing unit 3 to a junction 7 that is embodied to be switchable, to optionally guide the brewed beverage either through a line 13 to a beverage dispenser 15, or to a feed line 8 and into a collecting container 9. The lower region of the collecting container 9 is funnel-shaped and comprises a switchable valve 11 on an outlet 10, wherein this valve opens or closes a discharge 12 leading to a beverage dispenser 15.

The beverage dispenser 15 is shown schematically as a collecting device provided with an outlet, underneath of which a container 14, in particular a cup, is deposited.

An ice dosage device 16, which can be operated automatically to release one or a plurality of ice cubes into the device 2, is provided above the device 2 for supplying the ice. The ice dosage device 16 can be a collecting container, or a collecting device for ice cubes or a device for producing ice cubes as disclosed, for example, in commonly-owned U.S. application Ser. No. ______ (Atty. Docket 31928-284230) filed concurrently with this application, the content of which is incorporated herein by reference in its entirety.

The device 2 for supplying the ice comprises a container with a therein arranged disc 17 for comminuting the ice. The disc 17 is driven by a motor 19 via a shaft 18, wherein optionally a gear and/or a coupling can also be used. Projecting from this disc 17 is a circulating element 20 for moving the ice cubes arranged in the container against a schematically indicated blade 23, so that the cubes in the comminuted form can be released to the collecting container 9, as indicated with the arrow 21. The blade 23 is arranged on the container so that it can be adjusted for predetermining the size of the comminuted ice. If an automatic adjustment is provided, the size of the ice chips can be selected with the aid of a control unit, in dependence on the selected beverage.

A switchable discharge can be activated if the ice chips are to be dispensed directly into the container 14, wherein the ice chips can be transported directly from the device 2 for supplying ice to the beverage dispenser 15, as indicated with the schematically shown line 22.

For the dispensing of a hot beverage, the brewing unit 3 is filled with hot water and an extraction substance and subsequently releases the brewed beverage via the line 6 and the line 13 to the beverage dispenser 15.

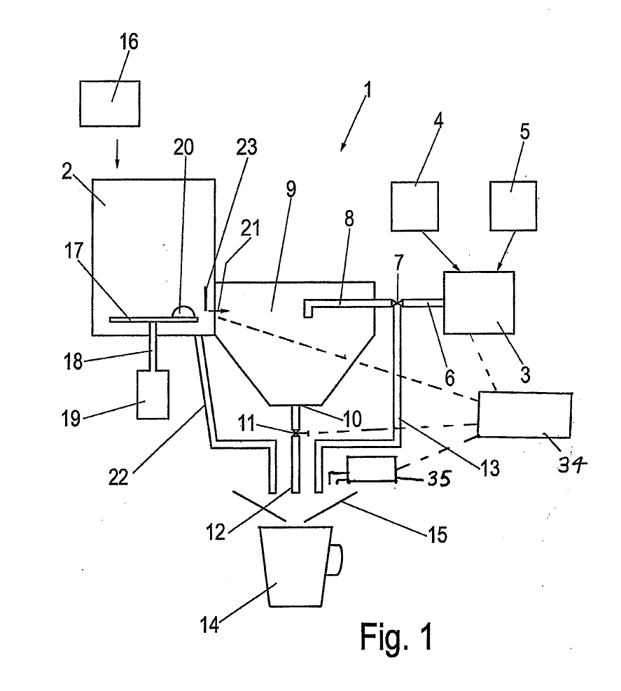

Insofar as the dispensing of a cold beverage is desired, for example ice coffee or ice tea, the brewed beverage may be cooled inside the appliance 1, wherein the brewing unit 3 is be activated and, parallel thereto, one or several ice cubes can be provided via the dosage device 16 to the device 2 for supplying the ice. In the device 2, the one or plurality of ice cubes are then comminuted or crushed and transferred to the collecting container 9. In the collecting container 9, the brewed beverage arriving from the line 8 and the crushed ice cubes from the device 2 are then collected, wherein the valve 11 can be closed for a specified interval, for example ranging from 10 to 60 seconds. During this time, the crushed ice cubes in the collecting container 9 will dissolve and can cool the brewed beverage to the desired temperature. Following this interval, the valve 11 can be opened with the aid of an adjustment element and the cooled beverage can be fed via the dispensing line 12 of the beverage dispenser 15 into the container 14. A central control unit 34 for the appliance 1 can be used to control the brewing unit 3, the device 2, as well as the valve 11, as represented by the dashed lines in FIG. 1. This control unit can comprise a control panel and a display for selecting the program for preparing different beverages.

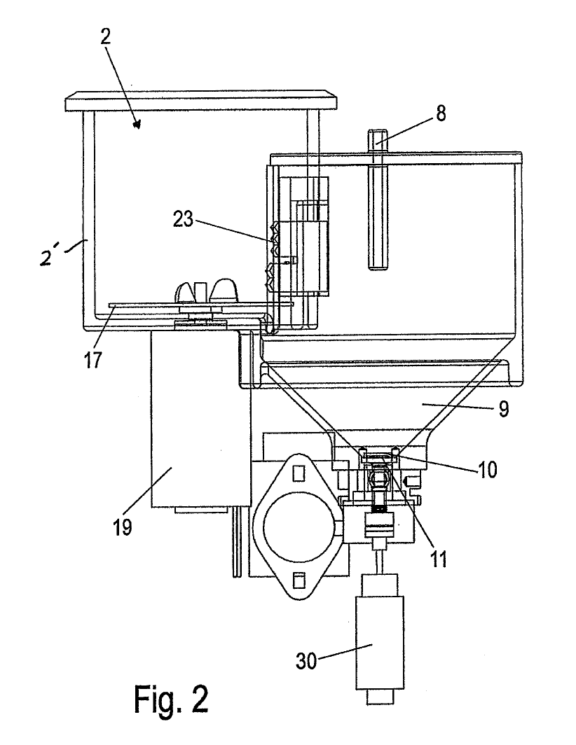

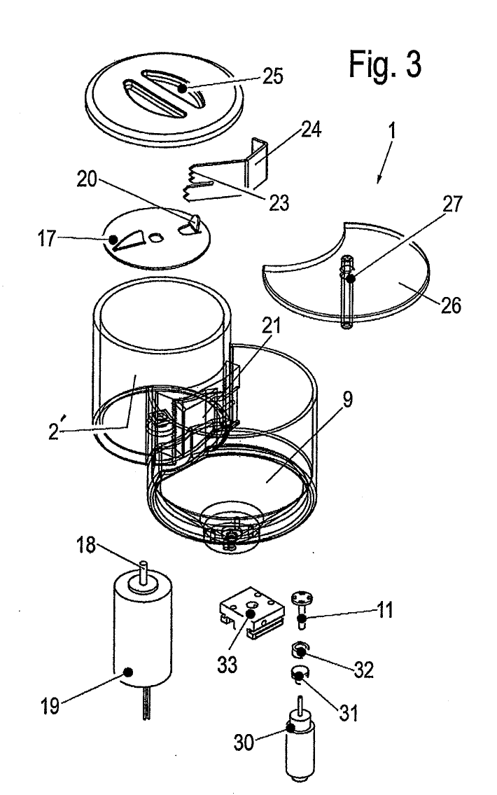

FIGS. 2 and 3 show further details of the device 2 for supplying ice in the appliance 1. The motor 19 drives the shaft 18 which extends through a bottom of a container 2′ for the device 2 for supplying ice and rotates the disc 17 therein. This disc is provided with one or several projections for circulating the ice cubes. A blade 23 is furthermore installed on the container 2′ which is embodied integrally with a holding device 24 (see FIG. 3) that is affixed to one wall of the container. A cover 25 is used to close the container 2′ of the device 2 for supplying ice, wherein the ice cubes can optionally be added manually or are supplied automatically with the aid of the ice dosage device 16.

The collecting container 9 is arranged adjacent to and slightly below the device 2 for supplying ice, so that comminuted ice can be released directly into the collecting container 9 through an outlet 21 on the container 2′. The collecting container 9 can also be closed with a cover 26 on which a feed line 27 for a brewed beverage is embodied.

An outlet 10 with a valve 11, arranged movable thereon, is provided on the underside of the collecting container 9. The valve 11 is operated with the aid of an actuator 30, provided for moving the valve 11 via a tappet 31 and a pressure disk 32, wherein a valve housing 33 is furthermore also arranged on the outlet 10.

To further expand the functionality of the appliance, one or more dosage devices 35 for aromatic substances and especially syrup can also be provided, for example in the region of the beverage dispenser 15, so that these substances can be dosed directly into the container 14 under the control of central control unit 34.

It will be understood that the above description of the present invention is susceptible to various modifications, changes and adaptations, and the same are intended to be comprehended within the meaning and range of equivalents of the appended claims.

What is claimed is:

1. An appliance for dispensing a beverage, comprising:
a brewing unit through which hot water can flow through an extraction substance to produce a brewed beverage;
a collecting container arranged to receive the brewed beverage from the brewing unit;
a beverage dispenser arranged to receive a prepared beverage from the collecting unit and to fill a container with the prepared beverage; and
a device arranged to supply ice to the collecting container, wherein the brewed beverage is permitted to flow through the collecting container with the ice therein as the prepared beverage to the beverage dispenser.

2. The appliance according to claim 1, wherein the collecting container includes an outlet and a valve that can be opened and closed to control delivery of the prepared beverage to the beverage dispenser.

3. The appliance according to claim 1, further including a fluid line coupled between the brewing unit and the beverage dispenser so that the brewed beverage can selectively flow from the brewing unit to the collecting container or directly to the beverage dispenser.

4. The appliance according to claim 1, wherein the device to supply ice includes a device to comminute or crush the ice.

5. The appliance according to one claim 1, further including an automatic dosage device to furnish ice in doses to the device to supply the ice.

6. The appliance according to claim 1, wherein the device to supply ice comprises a container and a driven disc arranged in the container to comminute the ice.

7. The appliance according to claim 1, and further including an ice supply line coupled between the device to supply ice and the beverage dispenser so that ice can be selectively supplied to the collecting container or directly to the beverage dispenser.

8. The appliance according to claim 1, further comprising a control unit which allows selecting different programs for the automatic dispensing of hot or cold beverages.

9. The appliance according to claim 1, wherein the collecting container is funnel shaped.

10. The appliance according to claim 1, wherein the device to supply ice is arranged above the collecting container and the collecting container is arranged above the beverage dispenser.

11. The appliance according to claim 1, wherein the collecting container is removable from inside the appliance.
